(19) United States
(12) Patent Application Publication
(10) Pub. No.: US 2026/0054234 A1
(43) Pub. Date: Feb. 26, 2026

(54) JET DEVICE FOR MIXING AND DISPENSING GLUE

(71) Applicant: SuZhou FSTW Electronic Technology CO.,LTD, Suzhou City (CN)

(72) Inventors: Hongguang Yu, Shenzhen City (CN); Xiaosong Fu, Shenzhen City (CN)

(21) Appl. No.: 19/377,811

(22) Filed: Nov. 3, 2025

(30) Foreign Application Priority Data
Sep. 10, 2025 (CN) 202511291666.1

(51) Int. Cl. B01F 27/1143; B01F 35/11; B01F 35/21; B01F 35/71; B01F 101/36; B05C 5/02

(52) U.S. Cl. CPC B01F 27/1143; B01F 35/11; B01F 35/2113; B01F 35/7175; B01F 35/71775; B01F 35/718051; B05C 5/0225; B01F 2101/36

(57) ABSTRACT

A jet device for mixing and dispensing glue. The jet device structurally includes glue feeding modules, a glue mixing module, a glue dispensing module, a cooling module, and a control module, where the at least two glue feeding modules are arranged, are in fluid communication with the glue mixing module through individual glue channels, and are capable of quantitatively conveying two-component glue at a constant pressure; a glue blending cavity and a spiral stirrer are arranged in the glue mixing module, two components of the glue converge in the glue blending cavity and are dynamically stirred and mixed by a stirring paddle, and stirring thrust pushes and guides the mixed glue to flow into the glue dispensing module; and the glue dispensing module drives, through a piezoelectric jet valve, a valve rod to move, to accurately jet the mixed glue.

### TECHNICAL FIELD

The present disclosure relates to the technical field of devices for dispensing glue, and particularly relates to a jet device for mixing and dispensing glue.

### BACKGROUND

As a critical product for fixedly connecting parts in industrial production and daily life, glue is extensively applied to electronic assembly, mechanical manufacture, home repair, and other scenes by virtue of no damage to surfaces of the bonded parts. At present, glue on the market is mainly divided into two categories: single-component glue and two-component glue. The single-component glue can be directly used alone for bonding, and thus is commonly applied due to convenience of use. However, in industrial scenes having a higher requirement for bonding strength, such as assembly of heavy machinery parts and connection of high-strength composite materials, a bonding effect of the single-component glue can hardly satisfy the requirement.

To resolve the technical problem in the high-strength bonding scenes, the two-component glue emerged. Two components of such glue have no bonding function when stored or used alone, and can have a chemical reaction to form a high-strength bonding layer only when evenly mixed in a specific ratio and applied to parts to be bonded. Thus, the two-component glue is widely applied in the industrial field. In industrial production, the two-component glue can be used only by a special device for supplying two-component glue. Two components of the glue are mixed in a predetermined ratio, and then the mixed glue is sprayed onto a surface of a workpiece to be bonded. However, a workflow of an existing conventional device for supplying two-component glue has obvious limitations. The two components of the glue have to be statically mixed. Only after mixing is completed, subsequent spraying can be performed. The mixing and the spraying cannot be synchronously implemented during glue supplying. Thus, a procedure interval exists in an overall processing flow, and operation time in a single period is relatively long. Especially in batch production, a requirement of an industrial production line for efficient processing can be hardly satisfied, and improvement in production efficiency is restricted.

In addition, during mixing by some existing devices, mixing uniformity is likely to be affected by viscosity of the glue and a fluctuation of the mixing ratio, which may lead to unstable bonding strength. Moreover, if the mixed glue early solidifies due to a change in temperature when conveyed to a spraying port, a flow channel may be blocked, spraying quality may be reduced, and production stability and a product yield may be further affected. Thus, it is urgent to develop a structure for supplying two-component glue, which can synchronously link glue supplying, mixing, and dispensing and balance mixing uniformity and an anti-solidification effect, to break through the technical bottleneck of the existing devices.

### SUMMARY

To resolve the above technical problems, the present disclosure provides a jet device for mixing and dispensing glue.

The jet device for mixing and dispensing glue includes glue feeding modules, a glue mixing module, and a glue dispensing module. The at least two glue feeding modules are arranged and are in fluid communication with the glue mixing module through individual glue channels. The glue mixing module includes a glue blending housing. A glue blending cavity is provided in the glue blending housing in a vertical direction. Glue conveyed by the glue feeding modules converges in the glue blending cavity and is preliminarily mixed. The glue mixing module further includes a spiral stirrer. The spiral stirrer is composed of a stirring driving member and a stirring paddle. One end of the stirring paddle is in transmission connection to an output end of the stirring driving member, and the other end of the stirring paddle vertically extends into the glue blending cavity. Different components of the glue in the glue blending cavity are dynamically stirred and mixed through rotation of the stirring paddle. The mixed glue flows into the glue dispensing module along a bottom of the glue blending cavity, and is dispensed by the glue dispensing module.

By using the above technical solution, two-component glue is individually conveyed by a plurality of glue feeding modules. The glue in a glue blending cavity is dynamically stirred and mixed by matching a spiral stirrer in a glue mixing module. Moreover, the mixed glue is guided to a glue dispensing module, and then is accurately jetted by the glue dispensing module. By a cooling module, it is ensured that the glue is not early solidified during conveying and jetting. By the control module, all modules are coordinated for cooperative work. Thus, a procedure limitation of mixing first and spraying later of a traditional device is broken. Glue supplying, mixing, and dispensing are implemented.

Preferably, each glue feeding module includes a glue feeding housing. A glue feeding channel is provided in each glue feeding housing in a vertical direction. A glue inlet in communication with each glue feeding channel is provided on a side wall of the glue feeding housing. A glue feeding valve for accurately and quantitatively feeding the glue is fixedly mounted at each glue inlet.

Through the above technical solution, by a glue feeding valve, a supply state and a flow rate of glue can be accurately controlled, and waste or excessive glue supply caused by uncontrolled flow of the glue into a glue feeding channel is avoided. By the glue feeding channel, an individual and stable conveying path is provided for the glue, such that two components of the glue are ensured to not interfere with each other before entering a glue mixing module. Thus, a foundation is laid for subsequent quantitative glue supply in a predetermined ratio. Moreover, a leakage risk of the glue in an initial stage of conveying is reduced.

Preferably, each glue feeding module further includes a glue feeding propeller. Each glue feeding propeller includes a sleeve and a screw rod. Each sleeve is fixedly mounted in the glue feeding channel. An axis of each screw rod coincides with an axis of the sleeve. Each glue feeding propeller further includes a direct-current electric motor. Each direct-current electric motor is arranged in a cavity in the glue feeding housing. An output shaft of each direct-current electric motor is in transmission connection to the screw rod. Each screw rod is driven to rotate in the sleeve by the direct-current electric motor, to push the glue to be conveyed to the glue mixing module along the glue feeding channel.

Through the above technical solution, when a screw rod is driven to rotate in a sleeve by a direct-current electric motor, stable axial thrust can be generated through a spiral fit between the screw rod and the sleeve such that glue can be pushed to move to a glue mixing module along a glue feeding channel at a uniform speed. Thus, a glue conveying interruption caused by insufficient gravity or a pressure fluctuation is avoided. Moreover, by adjusting and controlling a rotation speed of the direct-current electric motor, a glue conveying rate can be accurately controlled, and two-component glue can be accurately supplied in a predetermined ratio. Thus, the above technical solution is adapted to production requirements of different mixing ratios, and controllability of glue supply is improved.

Preferably, each glue channel includes a glue blending channel front segment and a glue blending channel rear segment. Each glue blending channel front segment is provided in the glue feeding housing in a glue flow direction. One end of each glue blending channel front segment is in communication with the glue feeding channel, and the other end of each glue blending channel front segment is in communication with the glue blending channel rear segment. A pressure sensor is mounted outside each glue feeding housing. A measurement end of each pressure sensor extends into a joint between the glue blending channel front segment and the glue feeding channel, and is configured to monitor a pressure of the glue in the glue feeding channel in real time.

Through the above technical solution, through a segmented design of a glue blending channel front segment and a glue blending channel rear segment, smooth transition of glue between glue feeding modules and a glue mixing module is implemented. Glue retention or pressure loss caused by non-smooth linkage of channels is avoided. A pressure sensor monitors a pressure at a joint between a glue feeding channel and the glue blending channel front segment in real time, can capture an anomaly of a pressure in time, such as a sudden rise of a pressure caused by channel blockage or a sudden drop of a pressure caused by insufficient glue, and can feed back a signal to a control module. Thus, the control module can rapidly adjust a glue supply parameter, an influence on production caused by damage on a channel or insufficient glue supply is prevented, and stability and safety of glue supply are ensured.

Preferably, each glue blending channel rear segment is provided in the glue blending housing in a glue flow direction. One end of the glue blending channel rear segment is in communication with the glue blending channel front segment, and the other end of the glue blending channel rear segment is in communication with the glue blending cavity. A communication position is located at an upper-middle portion of the glue blending cavity, to ensure the glue to smoothly flow into the glue blending cavity.

Through the above technical solution, a communication position between a glue blending channel rear segment and a glue blending cavity is arranged at an upper-middle portion of a glue blending cavity. On the one hand, reverse flow of mixed glue in the glue blending cavity into the glue blending channel rear segment due to a pressure can be avoided, and blockage caused by early mixing and solidification of different components of the glue in a channel can be prevented. On the other hand, when two components of the glue obliquely flow in from the upper-middle portion of the glue blending cavity, a preliminary swirling flow effect is formed in the cavity for premixing. Thus, a foundation is laid for subsequent dynamic stirring by a spiral stirrer, and overall mixing efficiency and uniformity are improved.

Preferably, a glue dispensing channel front segment is provided in the glue blending housing. One end of the glue dispensing channel front segment is in communication with the bottom of the glue blending cavity, and the other end of the glue dispensing channel front segment extends to the bottom of the glue blending housing. The glue dispensing channel front segment is provided below an axial tail end of the stirring paddle. Downward thrust generated by the rotation of the stirring paddle pushes the mixed glue into the glue dispensing channel front segment.

Through the above technical solution, a glue dispensing channel front segment is located below an axial tail end of a stirring paddle and in communication with a bottom of a glue blending cavity. Downward thrust generated through rotation of the stirring paddle can be fully used to directly push mixed glue to rapidly enter the glue dispensing channel front segment. Thus, early solidification caused by long-time retention of the glue in the glue blending cavity can be avoided. Moreover, through the design, mixing and guiding can be synchronously implemented. The mixed glue can be transported to a glue dispensing module without additional power. Thus, the structure of the device is simplified, energy consumption is reduced, and a risk of secondary pollution of the glue during transportation is reduced.

Preferably, the glue dispensing module includes a glue dispensing housing. A glue dispensing channel rear segment is provided in the glue dispensing housing. The glue dispensing channel rear segment is in communication with the glue dispensing channel front segment. A glue dispensing cavity in communication with the glue dispensing channel rear segment is provided in the glue dispensing housing. A nozzle mounting hole is provided at a bottom of the glue dispensing cavity. A nozzle is mounted in the nozzle mounting hole. A piezoelectric jet valve is mounted at a top of the glue dispensing cavity. A valve rod of the piezoelectric jet valve extends into the glue dispensing cavity. The valve rod is driven by expansion and contraction of a piezoelectric ceramic to move up and down, to control the glue to be jetted from the nozzle.

Through the above technical solution, a valve rod is driven, through a piezoelectric jet valve through rapid expansion and contraction of a piezoelectric ceramic, to move up and down, to accurately adjust and control an amount of glue jetted from the nozzle and a frequency at which the glue is jetted from the nozzle. Through sealed communication between the glue dispensing channel rear segment and the glue dispensing channel front segment, mixed glue is ensured to stably flow into a glue dispensing cavity. The nozzle can be designed to have different calibers and structures according to requirements such that the glue can be accurately attached to a surface of a workpiece to be bonded.

Preferably, the jet device for mixing and dispensing glue further includes a cooling module. The cooling module is configured to cool the glue dispensing cavity and the piezoelectric jet valve.

Through the above technical solution, a working temperature of a glue dispensing cavity and a working temperature of a piezoelectric jet valve can be effectively reduced by a cooling module through semiconductor cooling and other methods. A performance degradation or damage caused by overheating of the piezoelectric jet valve due to a long-time high-frequency operation is avoided, and service life of the piezoelectric jet valve is prolonged. Moreover, cooling strength is appropriately adjusted and controlled to assist in controlling a solidification speed of the discharged glue. Thus, bonding efficiency and quality can be improved.

Preferably, at least one cleaning channel is provided in the glue blending housing. One end of the cleaning channel is in communication with a side wall of a top of the glue blending cavity, and the other end of the cleaning channel extends to an outer wall of the glue blending housing. A cleaning valve is arranged at a location, corresponding to an extension end of the cleaning channel, outside the glue blending housing. By controlling opening and closing of the cleaning valve, a cleaning fluid is injected into the glue blending cavity, to clean the glue blending cavity, the stirring paddle, and the glue dispensing cavity.

Through the above technical solution, after an operation is finished or when a glue type is changed, by opening a cleaning valve, a cleaning fluid flows into a glue blending cavity through a cleaning channel. The cleaning fluid can fully wash residual glue on an inner wall of the glue blending cavity and a surface of a stirring paddle with the aid of low-speed rotation of the stirring paddle, and simultaneously flows along a glue dispensing channel and a glue dispensing cavity to remove residual glue on a nozzle and a valve rod. Through the design, mixed pollution of different batches or types of glue can be avoided. Blockage of a channel caused by solidification of residual glue is prevented. A disassembly frequency and a maintenance frequency of the device are reduced. Maintenance cost and time are reduced. Reusability and service life of the device are improved.

Preferably, the jet device for mixing and dispensing glue further includes a control module. The glue feeding modules, the glue mixing module, the glue dispensing module, the cooling module, and the control module are designed to be modularized and detachably connected through standardized interfaces.

Through the above technical solution, through matching between modularized designs and standardized interfaces, each module can be disassembled, maintained, or replaced individually. When one module fails, the device is not required to be entirely disassembled such that a maintenance difficulty and downtime are greatly reduced. Moreover, a number of glue feeding modules can be flexibly expanded according to a production requirement, such as multi-component glue dispensing. Or nozzles and stirring paddles, which are adapted to different glue types, can be replaced such that universality and flexibility of the device can be improved.

In summary, the present disclosure includes at least one of beneficial technical effects as follows:
1. Through coordinated work of quantitative and constant-pressure conveying by glue feeding modules, dynamic stirring and guiding by a glue mixing module, and precise jetting of a glue dispensing module, a procedure interval of mixing first and dispensing later of a traditional device is eliminated. Three core links are simultaneously performed such that operation time in a single cycle is greatly shortened.
2. In the glue mixing module, two components of the glue first obliquely flow in to form a preliminary swirling flow for premixing. Then, through dynamic shearing and stirring by a spiral stirrer, the components are ensured to be uniformly mixed. Thus, a fluctuation in bonding strength caused by uneven mixing is avoided.
3. Early solidification of the glue and overheating of a core part can be prevented by a cooling module. Residual glue can be completely removed to avoid blockage by a cleaning channel. By a control module, a pressure can be monitored in real time and protection can be performed in response to an anomaly, to reduce a failure risk of the device in a plurality of dimensions. Moreover, a faulty module can be rapidly replaced through a modularized design. A disassembly frequency and a maintenance frequency are reduced through a cleaning function. Through a combination of the modularized design and the cleaning function, maintenance difficulty and cost of the device are reduced, service life of the device is prolonged, and continuous and stable production is ensured.

### BRIEF DESCRIPTION OF THE DRAWINGS

FIG. 1 is a perspective view according to the embodiment and mainly shows an overall structure of the device;

FIG. 2 is another perspective view according to the embodiment and mainly shows an overall structure of the device;

FIG. 3 is a partial sectional view of the device and mainly shows specific structures of glue feeding modules and a specific structure of a glue mixing module;

FIG. 4 is an enlarged view of FIG. 3 and mainly shows structures of glue channels and a structure of a glue mixing module;

FIG. 5 is a partial sectional view of the device and mainly shows a specific structure of a glue dispensing module and a specific structure of a glue mixing module; and

FIG. 6 is a partial sectional view of the device and mainly shows a mounting location of a pressure sensor.

Descriptions of reference numerals: 10. glue feeding housing; 11. glue inlet; 12. glue feeding valve; 13. glue feeding channel; 14. glue blending channel front segment; 15. sleeve; 16. screw rod; 17. direct-current electric motor; 20. glue blending housing; 21. glue blending cavity; 22. glue blending channel rear segment; 23. stirring paddle; 24. stirring driving member; 25. glue dispensing channel front segment; 26. cleaning channel; 27. cleaning valve; 30. glue dispensing housing; 31. glue dispensing channel rear segment; 32. glue dispensing cavity; 33. nozzle; 34. piezoelectric jet valve; 35. valve rod; 40. cooling module; 50. control module; and 60. pressure sensor.

### DESCRIPTION OF THE EMBODIMENTS

The present disclosure is further described in detail in combination with accompanying drawings.

In the description of the present disclosure, it should be understood that orientational descriptions involved, such as orientational or positional relationships indicated by the terms “upper”, “lower”, “front”, “rear”, “left”, and “right” are based on orientational or positional relationships shown in accompanying drawings, and are only used for facilitating the description of the present disclosure and simplifying the description, rather than indicating or implying that a device or element indicated must have a particular orientation or be constructed and operated in a particular orientation. Thus, the orientational descriptions involved cannot be interpreted as limiting the present disclosure.

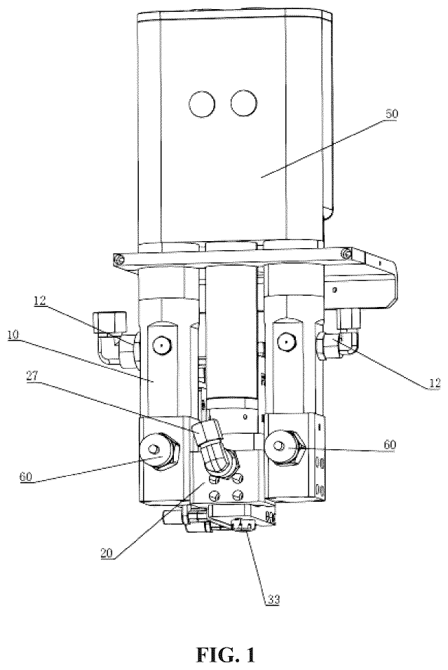

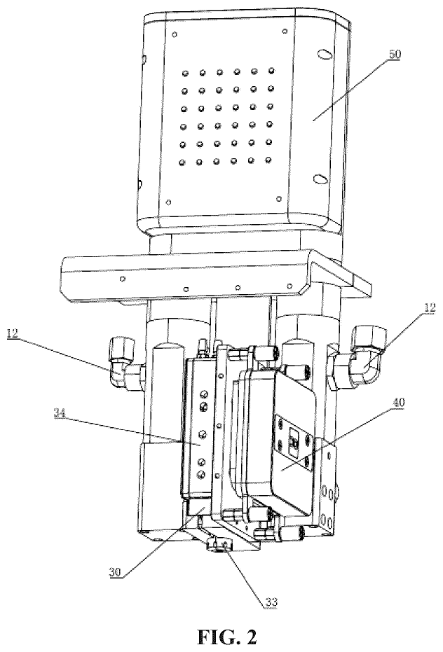

An embodiment of the present disclosure discloses a jet device for mixing and dispensing glue. With reference to FIG. 1 and FIG. 2, the jet device for mixing and dispensing glue includes glue feeding modules, a glue mixing module, a glue dispensing module, a cooling module 40, and a control module 50. In the embodiment, the two glue feeding modules are arranged. All the modules are designed to be modularized, and can be detachably connected through standardized mechanical interfaces, fluid interfaces, and electrical interfaces. Thus, a faulty module can be individually maintained or replaced. Moreover, a number of glue feeding modules can be expanded to be adapted to multi-component glue according to a production requirement.

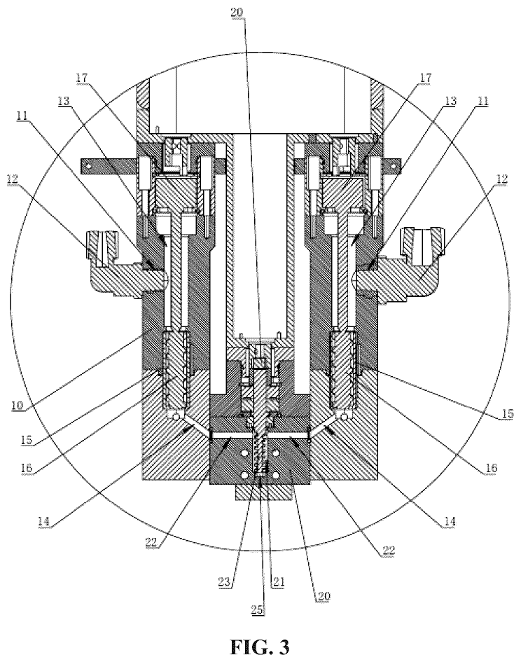

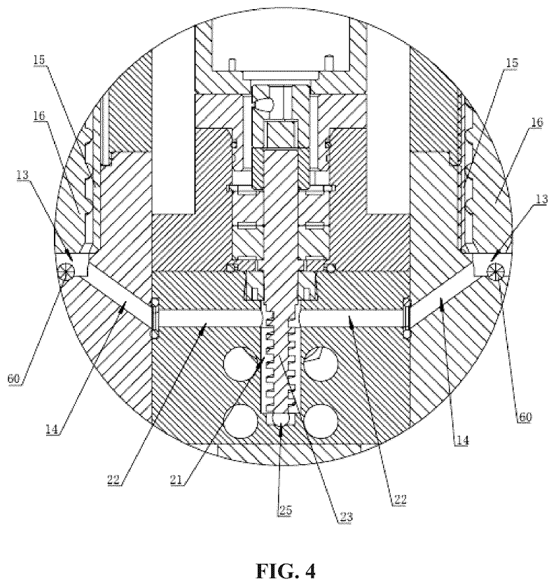

With reference to FIG. 3 and FIG. 4, the glue feeding modules are configured to quantitatively convey two-component glue at a constant pressure. Each glue feeding module includes a glue feeding housing 10, a glue feeding channel 13, a glue inlet 11, a glue feeding valve 12, a glue feeding propeller, and a pressure sensor 60. Each glue feeding housing 10 is a metal housing. Each cylindrical glue feeding channel 13 is provided in the glue feeding housing in a vertical direction. Each glue inlet 11 in vertical communication with the glue feeding channel 13 is provided on a side wall of the glue feeding housing 10. Each glue feeding valve 12 is fixedly mounted at the glue inlet 11 by a thread. Each glue feeding valve 12 is configured to accurately control a supply state and a flow rate of the glue. A sleeve 15 of each glue feeding propeller is fixed at a lower portion of the glue feeding channel 13 near the glue blending channel front segment 14 through an interference fit, to prevent glue leakage. An inner wall of the sleeve 15 is attached to an outer wall of a screw rod 16. A cavity for accommodating a direct-current electric motor 17 is provided at a top of each glue feeding housing 10. Each direct-current electric motor 17 is fixed in the cavity by a bolt. An output shaft of each direct-current electric motor is in transmission connection to a top end of the screw rod 16 by a coupler. Thus, it can be ensured that the electric motor can synchronously drive the screw rod 16 to rotate when rotating.

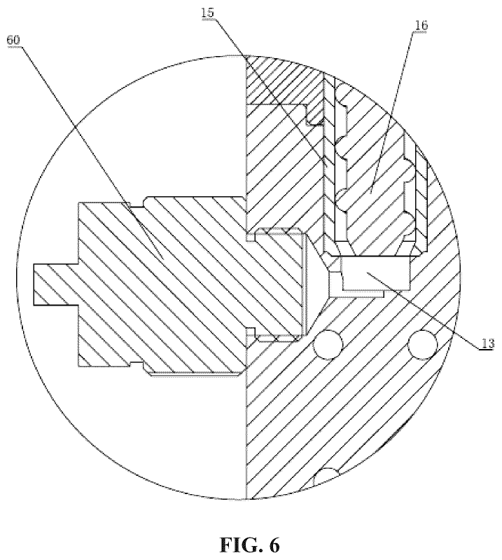

With reference to FIG. 3, FIG. 4, and FIG. 6, a mounting hole is provided on a front side wall of each glue feeding housing 10 and near a joint between the glue blending channel front segment 14 and the glue feeding channel 13. A measurement end of each pressure sensor 60 extends into the channel through the mounting hole. A housing of each pressure sensor is fixed on the glue feeding housing 10 by a nut. Thus, each pressure sensor is configured to monitor a pressure of the glue in the glue feeding channel 13 in real time.

With reference to FIG. 3 and FIG. 4, before work, the control module 50 receives a parameter set by a user, such as a mixing ratio of two pieces of glue having different components, and transmits instructions to the two glue feeding modules. The glue feeding valves 12 are powered on to be opened, glue having one component in an external glue storage tank corresponds to a first glue feeding module, and glue having another component corresponds to a second glue feeding module. The two pieces of glue flow into respective glue feeding channels 13 through glue inlets 11. The direct-current electric motors 17 are started to drive the screw rods 16 to rotate along axes of the sleeves 15. Rotation speeds of the electric motors of the two glue feeding modules are set according to the mixing ratio. Since the sleeves 15 are fixed, a spiral tooth surface of each screw rod 16 generates downward thrust on the glue, to push the glue to flow downwards along the glue feeding channel 13 to enter the glue blending channel front segment 14. Each pressure sensor 60 acquires a pressure signal at a joint between the glue feeding channel 13 and the glue blending channel front segment 14 in real time, and feeds back the signal to the control module 50. If a pressure is too high due to blockage of the channel, for example, the control module 50 reduces the rotation speeds of the direct-current electric motors 17 or closes the glue feeding valves 12, to avoid damage on the channels. If the pressure is too low due to insufficient glue, for example, an alarm signal is given to remind about glue replenishment, to quantitatively supply glue at a constant pressure.

With reference to FIG. 3 and FIG. 4, the glue mixing module is configured to dynamically mix and guide a plurality of components of the glue. The glue mixing module includes a glue blending housing 20, a glue blending cavity 21, a spiral stirrer, a glue blending channel rear segment 22, a glue dispensing channel front segment 25, and a cleaning channel 26. The cylindrical glue blending cavity 21 is provided in the glue blending housing 20 in a vertical direction. A diameter of the glue blending cavity 21 is greater than that of the glue feeding channel 13, to ensure sufficient mixing space for glue. In the embodiment, two glue blending channel rear segments 22 are symmetrically provided on an upper portion of the glue blending housing 20, and correspond to the glue blending channel front segments 14 of the two glue feeding modules respectively. One end of each glue blending channel rear segment 22 is in communication with the glue blending channel front segment 14. The other end of each glue blending channel rear segment obliquely extends downwards to an upper-middle portion of the glue blending cavity 21 to be in communication with the glue blending cavity 21. Through the oblique design, a preliminary swirling flow can be generated when the glue flows in, to assist in mixing. A cavity for accommodating a stirring driving member 24 is provided at a top of the glue blending housing 20. A driving electric motor is set as the stirring driving member 24. An output shaft of the driving electric motor penetrates a wall surface of the top of the glue blending housing 20 to be in transmission connection to a stirring paddle 23. A lower end of the stirring paddle 23 vertically extends into the glue blending cavity 21. A gap is reserved between a bottom of the stirring paddle and a bottom wall of the glue blending cavity 21, to avoid friction between a paddle blade and a cavity wall. A glue dispensing channel front segment 25 is provided at the bottom of the glue blending housing 20. Atop end of the glue dispensing channel front segment is in communication with the bottom of the glue blending cavity 21. An axis of the glue dispensing channel front segment 25 is located below an axial tail end of the stirring paddle 23. Thus, it is ensured that the glue can be directly pushed into the channel by thrust generated during rotation of the stirring paddle 23. The cleaning channel 26 is further provided at an upper portion of the glue blending housing 20 and near the side wall of the top of the glue blending cavity 21. One end of the cleaning channel 26 is in communication with the glue blending cavity 21. The other end of the cleaning channel extends to the outer wall of the glue blending housing 20. A cleaning valve 27 is mounted through a threaded connection.

With reference to FIG. 3 and FIG. 4, glue from the two glue feeding modules flows into the upper-middle portion of the glue blending cavity 21 at oblique angles through the glue blending channel front segments 14 and the glue blending channel rear segments 22. Since inflow directions of the two strands of glue are opposite, a preliminary swirling flow is formed in the glue blending cavity 21 and achieves preliminary mixing. The control module 50 synchronously starts the stirring driving member 24 to drive the stirring paddle 23 to rotate at a preset rotation speed. The rotation speed is adjusted according to viscosity of the glue. The higher the viscosity, the higher the rotation speed. The propeller blade of the stirring paddle 23 can shear and stir the glue, to ensure two components to be uniformly mixed. Moreover, the spiral structure of the propeller blade generates downward axial thrust, to push the mixed glue to flow to the bottom of the glue blending cavity 21. Under the action of the thrust of the stirring paddle 23, the uniformly mixed glue smoothly enters the glue dispensing channel front segment 25 at the bottom of the glue blending cavity 21, flows downwards along the channel, and enters the glue dispensing channel rear segment 31 of the glue dispensing module. Thus, mixing and guiding are synchronized, and retention of the glue in the glue blending cavity 21 is avoided.

With reference to FIG. 1, FIG. 3, and FIG. 4, when dispensing is finished or a glue type is required to be changed, the control module 50 controls the glue feeding valves 12 and the stirring driving member 24 to stop working, and then starts cleaning. The cleaning valve 27 is powered on to be opened, such that an external cleaning fluid flows into the top of the glue blending cavity 21 through the cleaning channel 26. The control module 50 starts the stirring driving member 24 again to drive the stirring paddle 23 to rotate at a low speed, such that the cleaning fluid forms a swirling flow in the glue blending cavity 21, to sufficiently washes an inner wall of the glue blending cavity 21 and a surface of the stirring paddle 23. Under the action of gravity and stirring thrust, the cleaning fluid flows out along the glue dispensing channel front segment 25, the glue dispensing channel rear segment 31, the glue dispensing cavity 32, and the nozzle 33, and washes the entire fluid channel simultaneously for cleaning. After the cleaning, the cleaning valve 27 is closed, and compressed air is started to dry residual cleaning fluid in the channel. Thus, quality of subsequent dispensing is prevented from being affected.

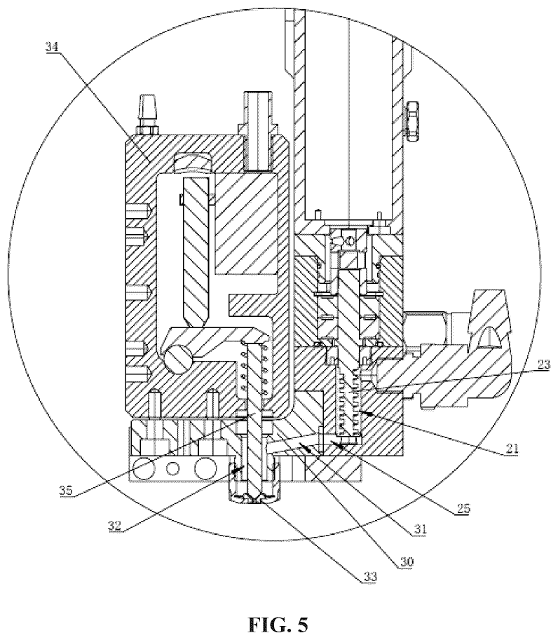

With reference to FIG. 4 and FIG. 5, the glue dispensing module is configured to precisely jet and dispense the mixed glue. The glue dispensing module includes a glue dispensing housing 30, a glue dispensing channel rear segment 31, a glue dispensing cavity 32, a nozzle 33, and a piezoelectric jet valve 34. The glue dispensing channel rear segment 31 is provided in the glue dispensing housing 30. The glue dispensing channel rear segment 31 and the glue dispensing channel front segment 25 of the glue blending housing 20 are coaxial and are connected to each other in a sealed manner. The cylindrical glue dispensing cavity 32 is provided at a lower portion of the glue dispensing housing 30. Atop end of the glue dispensing cavity 32 is in communication with a bottom end of the glue dispensing channel rear segment 31. A nozzle 33 mounting hole is provided at a bottom end of the glue dispensing cavity. A nozzle 33 is connected to the nozzle 33 mounting hole in a sealed manner. The piezoelectric jet valve 34 is fixedly mounted at the top of the glue dispensing housing 30 by a bolt. A valve rod 35 of the piezoelectric jet valve 34 extends into the glue dispensing cavity 32. A top end of the valve rod 35 is connected to a piezoelectric ceramic in the piezoelectric jet valve 34. The valve rod 35 is driven, through expansion and contraction of the piezoelectric ceramic, to move up and down.

With reference to FIG. 4 and FIG. 5, the mixed glue flows into the glue dispensing cavity 32 through the glue dispensing channel rear segment 31. The control module 50 transmits an electrical signal to the piezoelectric jet valve 34 according to a glue dispensing requirement of a workpiece to be bonded, such as a glue dispensing amount, a glue dispensing frequency, and a glue dispensing location. When glue is required to be discharged, the piezoelectric ceramic is powered on to axially contract, to drive the valve rod 35 to move upwards. At this time, an internal volume of the glue dispensing cavity 32 increases, a pressure decreases, and the glue dispensing cavity 32 is rapidly filled with the glue under the action of atmospheric pressure and upstream thrust. Then, the piezoelectric ceramic is powered off, restores to an original state, and generates reverse thrust, to drive the valve rod 35 to rapidly move downwards to squeeze the glue in the glue dispensing cavity 32. As the volume of the glue dispensing cavity 32 sharply decreases, under the action of the pressure, the glue is jetted from the nozzle 33 in a columnar form, or in a mist form according to a requirement. The glue is accurately attached to the surface of the workpiece to be bonded. The above actions are repeated to continuously dispense the glue. The control module 50 can accurately control the glue dispensing amount by adjusting time and voltage of powering on the piezoelectric ceramic, to satisfy requirements of different working conditions.

With reference to FIG. 1 and FIG. 2, the cooling module 40 is configured to prevent overheating of a part. The cooling module 40 employs a semiconductor cooling method. The cooling module 40 is mounted on an outer side wall of the glue dispensing housing 30 and at a location corresponding to the glue dispensing cavity 32 and the piezoelectric jet valve 34. The cooling module 40 can further be configured to improve a solidification speed of the glue. The cooling module 40 cools the glue dispensing cavity 32. Since the glue only temporarily stays in the glue dispensing cavity 32, the discharged glue can be rapidly solidified by cooling the glue dispensing cavity 32.

With reference to FIG. 1 and FIG. 2, the control module 50 cooperates, through electrical interfaces, with the glue feeding valves 12, the direct-current electric motors 17, the pressure sensors 60 of the glue feeding modules, the stirring driving member 24 and the cleaning valve 27 of the glue mixing module, the piezoelectric jet valve 34 of the glue dispensing module, and the cooling module 40. The user sets, by the control module 50, parameters such as a glue component ratio, a glue supplying pressure, a stirring rotation speed, a glue dispensing amount, and a glue dispensing frequency. The pressure sensor 60 feeds back a measurement signal to the control module 50. If an anomaly occurs, the control module 50 immediately gives an alarm signal, and performs a protective action according to a type of the anomaly, for example, stops feeding glue.

An implementation principle of an embodiment of the present disclosure is as follows: a user sets a parameter by the control module 50. The control module 50 starts two glue feeding modules, the glue feeding valves 12 are opened, and the direct-current electric motors 17 drive the screw rods 16 to push glue into the glue blending cavity 21. At the same time, the stirring driving member 24 drives the stirring paddle 23 to rotate, to dynamically mix the glue and push and guide the mixed glue to the glue dispensing module. After the mixed glue flows into the glue dispensing cavity 32, the piezoelectric jet valve 34 drives the valve rod 35 to move up and down under the command of the control module 50, to accurately jet the glue from the nozzle 33 to the workpiece. The cooling module 40 reduces a temperature of the glue dispensing cavity 32 or the piezoelectric jet valve 34. After the operation ends, the control module 50 stops glue feeding and glue dispensing, and starts cleaning. The entire fluid channel is washed by the cleaning fluid, residual fluid is dried, and the device is cleaned. According to the embodiment, glue supplying, mixing, and dispensing are synchronously performed through precise matching between the modules. Thus, problems of a long procedure interval and low efficiency of a traditional device are resolved.

All of the above embodiments are preferred embodiments of the present disclosure, and are not intended to limit the scope of protection of the present disclosure. Thus, equivalent changes made according to the structure, shape, and principle in the present disclosure should all fall within the scope of protection of the present disclosure.

What is claimed is:

1. A jet device for mixing and dispensing glue, comprising glue feeding modules, a glue mixing module, and a glue dispensing module, wherein the at least two glue feeding modules are arranged and are in fluid communication with the glue mixing module through individual glue channels, the glue mixing module comprise a glue blending housing, a glue blending cavity is provided in the glue blending housing in a vertical direction, glue conveyed by the glue feeding modules converges in the glue blending cavity and is preliminarily mixed, the glue mixing module further comprises a spiral stirrer, the spiral stirrer is composed of a stirring driving member and a stirring paddle, one end of the stirring paddle is in transmission connection to an output end of the stirring driving member, the other end of the stirring paddle vertically extends into the glue blending cavity, different components of the glue in the glue blending cavity are dynamically stirred and mixed through rotation of the stirring paddle, and the mixed glue flows into the glue dispensing module along a bottom of the glue blending cavity, and is dispensed by the glue dispensing module.

2. The jet device for mixing and dispensing glue according to claim 1, wherein each glue feeding module comprises a glue feeding housing, a glue feeding channel is provided in each glue feeding housing in a vertical direction, a glue inlet in communication with each glue feeding channel is provided on a side wall of the glue feeding housing, and a glue feeding valve for accurately and quantitatively feeding the glue is fixedly mounted at each glue inlet.

3. The jet device for mixing and dispensing glue according to claim 1, wherein each glue feeding module further comprises a glue feeding propeller, each glue feeding propeller comprises a sleeve and a screw rod, each sleeve is fixedly mounted in the glue feeding channel, an axis of each screw rod coincides with an axis of the sleeve, each glue feeding propeller further comprises a direct-current electric motor, each direct-current electric motor is arranged in a cavity in the glue feeding housing, an output shaft of each direct-current electric motor is in transmission connection to the screw rod, and each screw rod is driven to rotate in the sleeve by the direct-current electric motor, to push the glue to be conveyed to the glue mixing module along the glue feeding channel.

4. The jet device for mixing and dispensing glue according to claim 3, wherein each glue channel comprises a glue blending channel front segment and a glue blending channel rear segment, each glue blending channel front segment is provided in the glue feeding housing in a glue flow direction, one end of each glue blending channel front segment is in communication with the glue feeding channel, the other end of each glue blending channel front segment is in communication with the glue blending channel rear segment, a pressure sensor is mounted outside each glue feeding housing, and a measurement end of each pressure sensor extends into a joint between the glue blending channel front segment and the glue feeding channel, and is configured to monitor a pressure of the glue in the glue feeding channel in real time.

5. The jet device for mixing and dispensing glue according to claim 4, wherein each glue blending channel rear segment is provided in the glue blending housing in a glue flow direction, one end of a glue feeding channel rear segment is in communication with the glue blending channel front segment, the other end of the glue feeding channel rear segment is in communication with the glue blending cavity, and a communication position is located at an upper-middle portion of the glue blending cavity, to ensure the glue to smoothly flow into the glue blending cavity.

6. The jet device for mixing and dispensing glue according to claim 1, wherein a glue dispensing channel front segment is provided in the glue blending housing, one end of the glue dispensing channel front segment is in communication with the bottom of the glue blending cavity, the other end of the glue dispensing channel front segment extends to the bottom of the glue blending housing, the glue dispensing channel front segment is provided below an axial tail end of the stirring paddle, and downward thrust generated by the rotation of the stirring paddle pushes the mixed glue into the glue dispensing channel front segment.

7. The jet device for mixing and dispensing glue according to claim 6, wherein the glue dispensing module comprises a glue dispensing housing, a glue dispensing channel rear segment is provided in the glue dispensing housing, the glue dispensing channel rear segment is in communication with the glue dispensing channel front segment, a glue dispensing cavity in communication with the glue dispensing channel rear segment is provided in the glue dispensing housing, a nozzle mounting hole is provided at a bottom of the glue dispensing cavity, a nozzle is mounted in the nozzle mounting hole, a piezoelectric jet valve is mounted at a top of the glue dispensing cavity, a valve rod of the piezoelectric jet valve extends into the glue dispensing cavity, and the valve rod is driven by expansion and contraction of a piezoelectric ceramic to move up and down, to control the glue to be jetted from the nozzle.

8. The jet device for mixing and dispensing glue according to claim 1, further comprising a cooling module, wherein the cooling module is configured to cool the glue dispensing cavity and the piezoelectric jet valve.

9. The jet device for mixing and dispensing glue according to claim 1, wherein at least one cleaning channel is provided in the glue blending housing, one end of the cleaning channel is in communication with a side wall of a top of the glue blending cavity, the other end of the cleaning channel extends to an outer wall of the glue blending housing, a cleaning valve is arranged at a location, corresponding to an extension end of the cleaning channel, outside the glue blending housing, and by controlling opening and closing of the cleaning valve, a cleaning fluid is injected into the glue blending cavity, to clean the glue blending cavity, the stirring paddle, and the glue dispensing cavity.

10. The jet device for mixing and dispensing glue according to claim 1, further comprising a control module, wherein the glue feeding modules, the glue mixing module, the glue dispensing module, the cooling module, and the control module are designed to be modularized and detachably connected through standardized interfaces.
